(19) United States
(12) Patent Application Publication
(10) Pub. No.: US 2006/0236944 A1
(43) Pub. Date: Oct. 26, 2006

(54) Signal device and method for activating a milking device

(76) Inventor: Werner Happel, Friesenried (DE)

Correspondence Address: OLIFF & BERRIDGE, PLC, P.O. BOX 19928, ALEXANDRIA, VA, 22320, US

(21) Appl. No.: 11/403,925

(22) Filed: Apr. 14, 2006

(30) Foreign Application Priority Data
Apr. 14, 2005 (DE) 102005017358.6
Mar. 10, 2006 (DE) 102006011563.5

(51) Int. Cl. A01J 7/00

(52) U.S. Cl. 119/14.14

(57) ABSTRACT

Disclosed is a signal device for a milking device and a method for the actuation of a milking device, with which the time of a first contact or preliminary manipulation of a teat of the animal which is to be milked is acquired and, as a function of this time, a signal is emitted for the manual or automatic positioning of the milking device and/or the starting of the milking process. With an alternative solution, the maintaining of the milking time can also be monitored by means of the signal device.

The invention relates to a signal device for a milking device, which has milking beakers for placing on the teats of an animal which is to be milked, and a method for actuating a milking device.

In addition to the factors related to the animal, the quality of milk and the yield also depend on human and technical influences. In this situation, account must be taken in particular of the individual milk characteristics of the udder area, such as the anatomical and morphological condition of the teats, the readiness for milking as a sum total of milk ejection and slacking of muscle tone, as well as the volume of milk dependent on lactation status (see in this connection Köhler, Stefan Daniel, Use of Process Parameters of Automatic Milking Systems for Application in Udder Disorders, with the Use of Fuzzy Logic).

Only a part of the milk formed from the udder is accessible for drawing off. This cistern milk, which is stored in the milk discharge system is only prevented from flowing out by the cistern closure muscle. The proportion of cistern milk fluctuates as a function of the lactation number, the lactation stage, and the time between milkings at least between 10 and 20% of the total milk volume. The majority of the milk yield is located in the glandular tissue of the udder, which consists of a large number of milk bladders (alevoli), in which the milk is formed and stored. This milk, referred to as alevolar milk, can only be drawn off if it is transferred by a neuro-hormonally controlled milk ejection reflex into the cistern area. This process is referred to in practice as the “influx of the milk”. This reflex can be triggered by manual or mechanical stimulation. Tactile stimulation on the teats of the udder, such as milking the first milk streams (first milk), manipulation during the cleaning of the udder, and/or what is referred to as “massage before milking”, during which the udder and teats are massaged, stimulate the emission of the hormone oxytocin, which leads in the udder to the influx of the milk into the milk ducts.

After the influx of the milk, the milking devices should be put in place immediately, since the effect of the milk emission hormone oxytocin only lasts for 6 to 8 minutes. Correct milking requires experience and routine, whereby setting the milking device milking device in operation too early may bring the animal into a stress situation, while putting the milking process in place and starting it after the influx of the milk can likewise have a negative effect on milk yield. Research has shown that from the stimulation of the udder (by hand or mechanically) until the influx of the milk (latency time) requires some 50-80 seconds.

Since as a rule several animals are serviced by one milker, it is extremely difficult for him to maintain this comparatively short period of time for all the animals. Accordingly, it may happen, especially with group milking stands, that the cows standing next to one another undergo preliminary milking one after the other, whereby the milker then sets the milking device in operation on the last cow, on which preliminary milking and udder cleaning has just been carried out. In this situation the risk arises that the milk influx has not yet taken place with this cow, while the time period referred to has already expired with regard to the cows standing in front, resulting in the milking device being applied too late.

The invention is based on the object of simplifying the application of the milking device in good time.

This object is resolved by a signal device for a milking device with the feature combination of Patent Claim 1 and by a method for the actuation of a milking device with the features of the ancillary Patent Claim 18.

According to the invention, a signal device is provided for a milking device, exhibiting a timer element for measuring the time from the first contact or preliminary treatment of the teats, and a signal generator for emitting a signal after the expiry of a period of time, which usually corresponds to the milk influx time (latency time). This consists as a rule of a period of time during which the teats are stimulated or undergo preliminary treatment and a waiting period. After this signal has been issued, the milking device, or, more precisely, the milking beakers of the milking device, are set in operation and/or the milking process is started.

By way of this solution according to the invention, the milker is kept constantly informed as to when the waiting time after the first stimulation has expired with regard to each individual animal, so that the milking process can be adjusted in an optimum manner to the latency time (influx of the milk). This guarantees a gentle milking process without any stress burden on the animal.

The handling of the signal device is particularly simple if, after the timer has started, the signal device initially emits a stimulation signal for the time duration of the recommended mechanical stimulation and then emits a milking start signal after the expiry of the first time period, during which the milking device is to be put in place or the milking process started if this second time period is exceeded, for preference the signal generator emits a time-exceeded signal so that the operator is informed accordingly and, as appropriate, data is also stored in a computer.

For better recognition, for example, one signal generator can be provided at the signal device for the emission of the stimulation signals and another signal generator for the pre-warning, milk-start, and time-exceeded signals. In the event of the signals emitted by the signal generators being optical signals, for preference the first signal generator is allocated a different colour to the other signal generator (s).

The readability of the signal device can be further improved if the signal generator emits pulsed signals, whereby the pulse frequency and/or the light duration differ for the pre-warning, start, and exceed signals.

For starting the timer, the signal device is provided with an actuating device, such as a button. If it is also intended that the milking time is also be acquired by the signal device, this can be provided with an additional actuating device for starting the timer for the milking time measurement.

With one preferred embodiment, the actuation device is equipped with an additional signal generator, which indicates the actuation of the first and/or second actuation device, so that the operating person can monitor whether the individual signal device is being operated in the proper manner.

The timer, by means of which the time from the first contact/preliminary handling of the teats is measured and by means of which the signal emission is controlled, can be adjusted individually to the individual animal by changing the time span. This adjustable time span amount for preference to between 30 and 90 seconds, whereby a mean value may lie at about 60 seconds.

In a largely automated variant of the signal device according to the invention, a memory is provided for the depositing of animal-related data, such as milk quantity, breed of animal, or lactation progress, whereby the said time span in relation to the individual animal can then be read out from the memory.

The read-out of the data relating to the individual animal can be effected automatically by means of an animal identifier or manually.

The signal emitted by the signal device can be optical and/or acoustic. In addition, in the event of the milking device being already set in place, the milking process can be started automatically after the expiry of the time span.

The signals can also be used for the actuation of a handling device for the placement or removal of the milking device.

The operation of the signal device according to the invention is particularly simple if a device is also provided for the manual or automatic resetting of the timer(s) after the issue of the signals.

Other advantageous further embodiments of the invention are the object of further sub-claims.

Preferred embodiments of the invention are explained in greater detail hereinafter on the basis of diagrammatic drawings. These show:

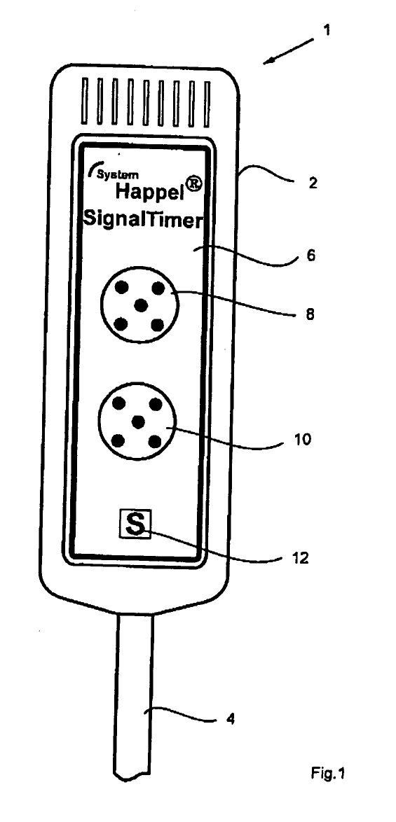

FIG. 1: A plan view of a first embodiment of a signalling device, and

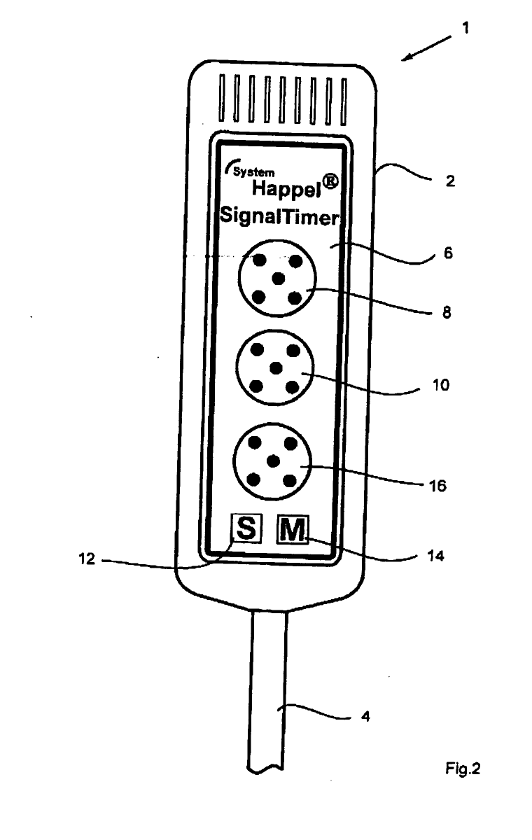

FIG. 2: A functionally-extended embodiment of the signal device from FIG. 1.

Provision is made for one of the signal devices according to the invention to be provided at each milking box or at the first animal of a group of 3 to 6 animals to be milked, which essentially has at least one optical signal generator, such as an easily visible warning light, and an acoustic signal generator, such as a buzzer. In addition, a display can be provided for at which a preset or alterable waiting time can be read off, and the actual time after a first contact/ stimulation of a teat of a cow can be read off. The signal device also has a button, such as a switch, which is actuated at the first contact/stimulation of the udder by the milker, in order to start a time measurement. By means of this time measurement the time is acquired which has passed from the first contact/stimulation of the udder. This time is calculated by means of a timer integrated into the signal device and, as appropriate issued at the display. The display can be arranged in such a way that data can be displayed relating to an individual animal, to the milking box, etc.

After the expiry of a predetermined time span, which can either be altered in a manner related to an individual animal or corresponds to a mean value, such as 60 seconds, an acoustic and optical signal is issued via the signal device, by means of which the milker is informed that the milking device is now to be put in place and/or the milking process must be started. As mentioned in the preamble, the time span which is set corresponds to the time which elapses from the first stimulation of the teats to the influx of the milk.

This first stimulation can be effected, for example, by the pre-milking or by the massage (massaging of the udder and teats).

The concept described heretofore can be set up in a very easily realised manner and can be fitted to any milk stand subsequently with minimum effort or expenditure.

In principle, this solution can also be automated to a very large extent, whereby the time span from the first contact with the udder through to the beginning of the milking process/placement of the milking device (more precisely, the placement of the milking beakers onto the teats) can be adjusted to the individual animal. With the manual variant described previously, this time span can be adjusted, for example by means of a rotary knob or the like. With the automated solution, for example, the time span can be adjusted as a function of a signal from a transponder allocated to the animal, whereby this time span individual to the animal is read out from a memory of the signal device. Animal-related data can be deposited in this memory, such as milk yield, breed, or lactation progress.

With fully-automated milk stands, it is possible for a signal to be issued from the signal device to the milking robot, whereupon this then carries out, for example, the pre-milking, udder cleaning, or stimulation of the udder, and the milking device is then put in place and the milking process is then started fully automatically and, if appropriate, removes the milking device again after the expiry of the milking time. The control system and the memory of the signal devices can be integrated in the central control unit of the milking installation, of which the signal outputs are connected to the signal devices. The signal device can also take the form of a transmitter (Bluetooth, mobile radio, etc.), by means of which a radio signal is issued to a mobile receiver (pager, SMS, or the like), by means of which the milker then receives a warning signal.

Specific embodiments of a signal device according to the invention are explained hereinafter, referred to by Applicants as the SignalTimer.

The embodiment represented in FIG. 1, in a similar manner to a remote control, has a plastic housing 2 which in plan view is approximately rectangular in shape, in which the printed circuit board is accommodated for actuating the signal displays described in greater details hereinafter. With the embodiment represented, the power supply of the SignalTimer is provided by means of the cable 4 (12-24 Volt DC), although naturally batteries or the like can also be used for the power supply. Two signal displays 8, 10, are arranged above one another on an operating panel 6 of the housing 2. Each of the signal displays 8, 10, consists of an LED module with several LED's, whereby the signal display on the top in FIG. 1 is green and the signal display below can emit a yellow light.

Arranged beneath the two signal displays 8, 10, is a button 12, which is designed, for example, as a membrane switch, and by means of which the timer unit of the SignalTimer can be started. Not represented are devices by means of which, if appropriate, the time interval described in greater detail hereinafter can be adjusted in this case in relation to the individual animal.

At the start of the pre-milking process or manual stimulation of the teats, the operator issues confirmation by means of the button 12, with the result that the timer is started. Correct starting is indicated by the yellow signal indicator 8 lighting up. As an option, a slow flashing of the yellow signal display can indicate the recommended duration of the mechanical stimulation of the udder. Shortly before the waiting time expires until the influx of the milk (about 60 seconds), the yellow signal display goes out and the green signal display B above it begins to flash slowly, so informing the operating person that the milking process can begin shortly. After the waiting time has expired and until the anticipated influx of the milk, the green signal display 8 switches over to a steady light, and the milking device must now be put in place or the milking process started. Once a predetermined tolerance period has expired, the signal display 10 switches over to rapid flashing, so informing the operator that he has waited too long with the placement of the milking device, and can make recourse to the appropriate measures, The optical signals described previously can be supported by appropriate acoustic signals, with the result that the operator is also informed that the predetermined waiting period has been exceeded, if he is not standing directly at the milking stand.

The SignalTimer can be reset to its basic state by actuating the button 12 once again. In principle, provision is made for the SignalTimer to be reset into the basic state automatically after a pre-set pause period.

In principle it is also possible for different time spans to be programmed in, which can then be called up by actuating the button 12 several times. In this case it is of advantage if the data files loaded in each case are identified by an optical display.

With the SignalTimer represented in FIG. 1, the placement of the milking device and the start of the milking process can be controlled and acquired after the first stimulation of the teats.

As well as the placement of the milking device, the maintaining of a predetermined milking time is also an important criterion for good milk quality. FIG. 2 represents a variant of the SignalTimer with which the milking time can also be monitored.

This SignalTimer is also operated at 12-24 Volt DC and has a housing 2 with an operating panel 6, on which two buttons 12, 14 are located next to one another, and three signal displays 8, 10, and 16 are arranged above one another in the perpendicular axis of the SignalTimer 1. The button 12 and the two signal displays 8, 10 correspond, with regard to structure and function, the corresponding structural elements in FIG. 1, with the result that comments and explanations relating to this are superfluous. The third signal display 16, located at the top, consists of an LED module emitting a red light, by means of which the milking time is displayed. The second button 14 serves to start the timer for acquisition of the milking time.

Exactly as in the embodiment described heretofore, at the start of the stimulation of the teats the button 12 is actuated, so that the yellow signal display 8 indicates that the timer for measuring the time span until the influx of the milk has been actuated. Shortly before the expiry of this time span, the yellow signal display 8 goes out and the green signal display 10 begins to flash slowly. When the waiting time expires (approx. 60 secs.), this signal display 10 switches to steady light and the operator must now put the milking device in place or start the milking process respectively. If this waiting time is exceeded by a preset tolerance time, the signal display 10 switches over to a rapid flashing light, so that the operator is warned visually and, if appropriate, also acoustically. With the starting of the milking process, the operator actuates the second button 14. This is then confirmed by the yellow signal display 8 lighting up, whereby this lighting up now represent the beginning of the milking process. The signal display 10 then goes out.

Shortly before the expiry of the optimum milking time (for preference 5 to 8 minutes), the upper signal display 16 starts to flash slowly, such that the operator is forewarned that the expiry of the milking time is imminent. After the expiry of the preset milking time, the signal display 16 switches over to a steady red light, and indicates that the milking process should be interrupted. If a predetermined tolerance time is exceeded, the signal display 16 switches over to rapid flashing, and indicates that the optimum milking time is being exceeded. As already mentioned, these visual signals can be supported by acoustic signals. If the milking time or the waiting time are exceeded by the time that milking begins, a data storage process relating to the individual animal can be carried out, so allowing for inferences to be drawn with regard to the milk quality.

Naturally, the signals emitted by the timer control can also be used to activate a technical device, such as a milking device remover or a milking arm, such that the milking process can be automated accordingly.

Initial practical tests have shown that the SignalTimers represented in FIGS. 1 and 2 represent a considerable easing of the burden on the operator, and also allow for an objective monitoring of the waiting times and the milking times. The use of the SignalTimer also allows for less well-trained or less experienced ancillary workers to work at the milking stand without the milk quality being impaired by incorrect handling.

The SignalTimer can be reset by, for example, repeat actuation of the second button 14. With the embodiment represented in FIG. 2, likewise, all the time spans can be adjusted to the individual animal. In principle, it is also possible for this data to be read in from a memory in relation to an individual animal.

With the signal device according to the invention and the method according to the invention for the actuation of a milking device, it is possible, with minimal effort and expenditure for the milking process to be controlled in such a way that it coincides with the influx of the milk or begins shortly thereafter, so guaranteeing that a smooth milking process is guaranteed.

The signal device and the method can be used with all types of animals which are to be milked. The preferred application, however, is for milking systems for cows.

Disclosed is a signal device for a milking device and a method for the actuation of a milking device, with which the time of a first contact or preliminary manipulation of a teat of the animal which is to be milked is acquired and, as a function of this time, a signal is emitted for the manual or automatic positioning of the milking device and/or the starting of the milking process. With an alternative solution, the maintaining of the milking time can also be monitored by means of the signal device.

### REFERENCE NUMBER LIST

1 SignalTimer
2 Housing
4 Mains power cable
6 Operating panel
8 Signal display
10 Signal display
12 Button
14 Second button
16 Signal display

1. Signal device for a milking device, which has a milking beaker for placing on the teats of an animal which is to be milked, with a timer for acquisition of a time period from the first contact or preliminary handling of the teats, and with a signal generator for emitting a signal after the expiry of a time span for the placement of a milking beaker on the teats or for starting the milking process respectively.

2. Signal device according to claim 1, whereby the signal generator emits a stimulation signal during a first time span after the first contact with the teats or from the beginning of the preliminary treatment, and, during a second time span consequent to this, emits a milking start signal, whereby, after the expiry of the first time span, the milking device is to be set in place or the milking process is to be started.

3. Signal device according to claim 1, whereby the signal generator emits a forewarning signal at the end of the first time span, and, after the expiry of the second time span for the milking start signal, emits an exceed signal.

4. Signal device according to claim 3, with a first signal generator for the stimulation signal and a second signal generator for the forewarning signal, the milking start signal, and the exceed signal.

5. Signal device according to claim 2, with a further signal generator to emit a signal after the expiry of a predetermined milking period.

6. Signal device according to claim 5, whereby the signal generator emits a forewarning signal at the end of the milking time, a milking device removal signal during the time span following this, and a milking time exceed signal following this.

7. Signal device according to claim 3 whereby the light emitted from the first signal generator is of a different colour to the light emitted by the other signal generator(s).

8. Signal device according to claim 2, whereby pulsed signals can be emitted and the forewarning, start, and exceed signals are differentiated by different pulse frequencies or light durations.

9. Signal device according to claim 1, with an actuation device for starting the timer at the first contact or preliminary treatment of the teats.

10. Signal device according to claim 9, with a second actuation device for starting the timer at the beginning of milking.

11. Signal device according to claim 10, with a third signal generator for emitting an activation signal after the actuation of the first or second actuation device.

12. Signal device according to claim 1, with a signal output for the emission of a control signal to a device for the largely automatic placement or removal of the milking system.

13. Signal device according to claim 1, whereby the signal generator emits a visual and/or acoustic signal and/or a radio signal.

14. Signal device according to claim 1, whereby the timer can be adjusted for the individual setting of the time spans.

15. Signal device according to claim 1, with a memory for the depositing of animal-related data, such as milk yield, breed, lactation progress, or for storing a warning notification that the first time span or the milking time has been exceeded.

16. Signal device according to claim 15, whereby the first time span amounts to between 5 and 90 seconds, for preference between 10-40 seconds, and/or the milking time to between 4 and 10, for preference 5-8 minutes.

17. Signal device according to claim 1, with a device for resetting the timer.

18. Method for the actuation of a milking device, with the steps:
Preliminary treatment of an udder of an animal which is to be milked;
Starting of a timer for measuring the time span from the first contact with the udder or a teat by hand or by mechanical devices.
and/or the starting of a timer for the measurement of the time span from the placement of the milking device or the starting of the milking process,
and
the issue of a signal for the placement of a milking device on the udder and/or for starting the milking process.

19. Method according to claim 14, whereby, after the expiry of a predetermined milking period a milking device removal signal is issued.
